(19) United States
(12) Patent Application Publication
(10) Pub. No.: US 2007/0129964 A1
(43) Pub. Date: Jun. 7, 2007

(54) Systems and methods for transporting ordered products

(75) Inventors: Hans-Ulrich von Helmolt, Heidelberg (DE); Carsten Kreuels, Contwig (DE); Volker Jaeck, Nussloch (DE)

Correspondence Address: SAP / FINNEGAN, HENDERSON LLP, 901 NEW YORK AVENUE, NW, WASHINGTON, DC, 20001-4413, US

(73) Assignee: SAP AG

(21) Appl. No.: 11/633,485

(22) Filed: Dec. 5, 2006

(30) Foreign Application Priority Data
Dec. 5, 2005 (EP) 05 111 712.5

(51) Int. Cl. G06Q 30/00

(52) U.S. Cl. 705/1

(57) ABSTRACT

Systems and methods are provided for processing a customer order specifying products and required quantities. In one implementation, a computer-implemented method performs a plurality of availability checks for the specified products with at least one location. Each availability check creates a result that comprises one or more products, locations, and available quantities. The method includes replacing the products and corresponding locations if a sum of available quantities within each of the results does not correspond to a required quantity of the specified products. The results may be arranged according to product and location. Further, the method may include selecting a plurality of results from the arranged results, wherein at least one of a number of different locations and a number of different products within the plurality of results is predetermined.

### BACKGROUND

1. Technical Field

The present invention generally relates to the field of data processing and to computerized systems and methods for managing products within e-business systems. More particularly, and without limitation, the invention relates to systems and methods for transporting ordered products from a supplier to a customer.

2. Background Information

Today, the success of a company depends essentially on the requirement that demands on goods and/or services be fulfilled precisely, cost-efficiently and in time. Accordingly, many companies make use of a supply chain management system to control and optimize their production and delivery processes.

Supply chain management may include the process of coordinating the flow of goods, services, information, and/or finances between parties, such as manufactures, suppliers, wholesalers, retailers, and consumers. This process may include, among other things, order processing, information feedback, and timely delivery of ordered goods and/or services. Supply chain management may also integrate and manage key processes along the supply chain.

The movement of products through a supply chain often involves the shipment of the products between a source location at which the product is produced or stored and a target location where the product is to be shipped, such as the vendor or customer. The source location from which a set of products is shipped is usually selected based on the availability of the products at the source location. In current supply chain, management systems availability of an ordered quantity of products is checked within an availability check process. This availability check process may be based on a list comprising a plurality of product locations which may be considered by the availability check. In general, the availability check process determines which products from which locations are available in order to fulfill the customer order. The result of the availability check process may comprise a plurality of locations, wherein each location provides only a part of the ordered quantity of products. However, these parts often have to be merged in a special location or have to be shipped as partial deliveries from each location to the customer.

### SUMMARY

In view of the foregoing, systems and methods are disclosed herein for overcoming one or more of the above-mentioned problems. In accordance with embodiments of the invention, systems and methods may be provided for managing products within e-business systems. More specifically, embodiments of the invention include systems and methods for transporting ordered products from a supplier to a customer.

Consistent with an embodiment of the present invention, a computer-implemented method processes a customer order specifying products and required quantities. The products may be located at least at one location. The method includes performing a plurality of availability checks in order to determine whether or not the ordered products are available at the at least one location. The availability check may include performing an availability check for the products with the at least one location, whereby each availability check creates a result, wherein the result may include at least a product, a location, and an available quantity. Further, the method may include replacing the products and corresponding locations if the sum of available quantities within the results does not correspond to the required quantities of products. Moreover, the method includes arranging the results according to product and location and selecting for further processing a plurality of results from the arranged results, wherein at least one of the number of different locations and the number of different products within the selected plurality of results is predetermined.

In one embodiment, the at least one availability check may be performed based on at least one ATP rule. The at least one ATP rule may indicate the object to be restricted within the selected plurality of results, whereby the object is at least one of a location and product. Furthermore, the at least one ATP rule may indicate at least one of a predetermined number of different locations and a predetermined number of different products.

As disclosed herein, the at least one ATP rule may be determined by evaluating a rule strategy sequence, wherein the rule strategy sequence comprises at least one rule strategy and the at least one rule strategy comprises at least one ATP rule. Further, the at least one rule strategy may indicate the object to be restricted within the selected plurality of results, wherein the object is at least one of a location and product. The at least one rule strategy may indicate at least one of a predetermined number of different locations and a predetermined number of different products.

In another embodiment of the present invention, the at least one rule strategy may indicate whether or not the at least one of the predetermined number of different locations, the predetermined number of different products, and the object to be restricted by the at least one ATP rule are overwritten with the at least one of the predetermined number of different locations and the predetermined number of different products and the object to be restricted of the at least one rule strategy.

Furthermore, at least one of the predetermined number of different locations and predetermined number of different products may comprise at least one of the values ‘no restriction’ and ‘one different object’. Methods consistent with the invention may perform an availability check with respect to all location products in order to determine the maximum available quantity for each location product. In a further embodiment of the invention, an interface may be provided for plugging in external programs for selecting the best result from the availability check process.

Furthermore, the method may comprise a step of determining and evaluating at least one rule strategy and a step of determining and evaluating the ATP rules of the determined at least one rule strategy.

Methods consistent with embodiments of the invention may include the steps of determining the requirements of the ATP rule, checking availability for the required quantity of products, aggregating the confirmed quantities with respect to the location and storing the aggregation within a bucket, and checking whether or not the a bucket can provide the requested quantity.

In one embodiment of the invention, the actual requested quantity may be the difference between the required quantity of products and the stored confirmed quantity of products.

In accordance with another embodiment of the invention, an apparatus may be provided that includes a data storage that stores a plurality of ATP rules, a plurality of rule strategies, a plurality of rule strategy sequences and confirmed quantities. In addition, the apparatus may include means for determining at least one rule strategy sequence, at least one rule strategy and at least one ATP rule, means for aggregating the confirmed quantities with respect to the location and storing the aggregation within a bucket, means for determining the actual requested quantity, and means for checking availability according to at least one of required quantity of products and actual requested quantity of products. Moreover, the means for determining the actual requested quantity and the means for checking availability may be adapted to perform steps according to methods consistent with the present invention.

Consistent with embodiments of the present invention, it is possible to restrict the number of different locations from which the products have to be shipped to the customer. Accordingly, it is possible to deliver products from one single location. It is also possible to restrict the number of different location products or different products during the availability check. Thus, it is possible to delivery only one specific product from only one specific location or only one specific product from different locations.

Furthermore, consistent with embodiments of the present invention, a number of locations may be check for several product alternatives. Additionally, the number of different locations checked may be restricted across several ATP rules in order to maximize the chance to get a confirmation for the ordered products.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates a diagram of an exemplary order process, consistent with an embodiment of the present invention;

FIG. 2 illustrates an exemplary relationship between rule strategy sequences, rule strategies, and ATP rules, consistent with an embodiment of the present invention;

FIG. 3 illustrates a flow diagram of an exemplary method, consistent with an embodiment of the present invention;

FIG. 4 illustrates a flow diagram of another exemplary method, consistent with an embodiment of the present invention;

FIG. 5 illustrates a flow diagram of a still further exemplary method, consistent with an embodiment of the present invention; and

FIG. 6 illustrates exemplary data tables, consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Often it is necessary for an enterprise to ship ordered products from a single location such as a warehouse, distribution center, or manufacturing plant, to a customer or a target location. In this case, a company may ship only one specific product from a specific location to the customer or to the target location. Accordingly, a required quantity of only one specific product should be available in exactly one location. This specific product may be also an alternative product, but it should be exactly one specific product, shipped from one specific location to the customer or to the target location.

There may be various reasons for transporting the ordered products with just one delivery to a target location. For example, this may reduce transportation costs, storage costs, and delivery times. Furthermore, a consolidation of a plurality of part deliveries can be avoided. Often it is more economic to transport a plurality of products as a single shipment from a distant location with reference to the target location as opposed to partial shipments from several close locations with reference to the target location. A further reason may be the availability of several transportation means at several product locations. For example, an emergency order may require transportation means like a train or airplane is available at the product location. In such a case, all the ordered products should be delivered from this special product location to the target location. This may be done by restricting the number of different locations, the number of different products, or the number of location products within the result list of an availability check.

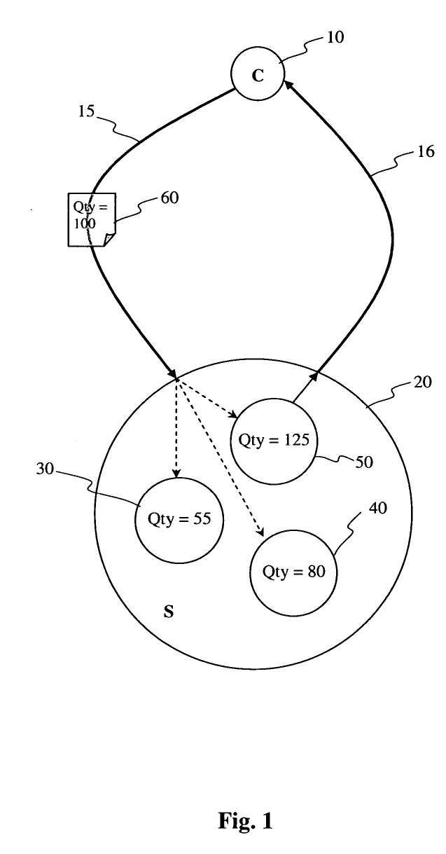

FIG. 1 illustrates a diagram of an exemplary order process, consistent with an embodiment of the present invention. A customer 10 sends 15 an order 60 to supplier 20. As shown in FIG. 1, order 60 specifies a quantity of 100 pieces of a product. In this example, the customer wishes that all the ordered products are delivered in one single delivery to him. In order to meet the customer requirement, supplier 20 tries to fulfill the customer order by checking the availability in several product locations 30, 40 and 50. Product location 30 provides 55 pieces, product location 40 provides 80 pieces and product location 50 provides 125 pieces of the ordered product. The availability check for product location 30 confirms a quantity of 55 pieces, the availability check for product location 40 confirms a quantity of 80 pieces. Product location 50 confirms a quantity of 125 pieces. Therefore, supplier 20 can fulfill the customer requirement by delivering 16 the ordered products as a single delivery from product location 50 to customer 10. Product locations 30, 40, 50 may be warehouses in different regions or different countries.

The locations that are included in the availability check may be defined by a plurality of ATP rules. An ATP rule is a customizing setting for a rules-based availability check. In one embodiment, an ATP rule comprises all combinations of products and locations to be checked. Additionally, an ATP rule may describe how the combinations of products and locations should be evaluated. The rules-based availability check is an iterative availability check process driven by a plurality of ATP rules. The result of one step determines whether and how the availability check process should be continued. For example:
Is the product P available in location L?
If not, is an alternative product AP available in location L?
If not, is the product P available in an alternative location AL?
If not, is an alternative product AP available in an alternative location AL?
If not, a production process is triggered.

In this example, both the alternative product AP and the alternative location AL are part of the ATP rule. A determination of the ATP rules which are to be applied in the availability check may be based on a plurality of parameters, for example, customer or order fields. For example, for the customer A the ATP rule RA may be relevant, whereas for customer B the ATP rule RB may be relevant. The ATP rule RA defines the locations L1 and L2 that are checked during an availability check, and the ATP rule RB defines the location L3. Therefore, a customer order coming from customer A is checked, according to the ATP rule RA, against locations L1 and L2.

The ATP rules may also define alternative products for products which are temporarily not available or for products for which successor products or product variants are available. Furthermore, the ATP rules may also define alternative product locations, for example if a product location is not available because of maintenance or natural disasters. With a supply chain management system, a plurality of rule strategy sequences may be defined including a plurality of rule strategies. Each rule strategy may include a plurality of ATP rules.

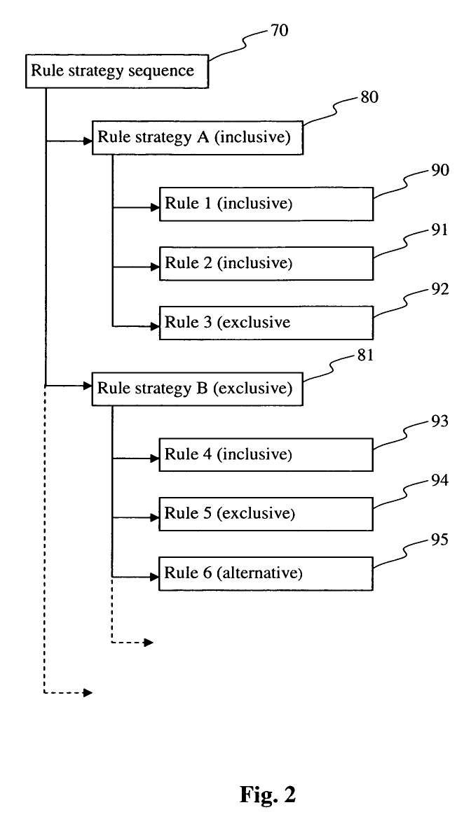

FIG. 2 shows an exemplary relationship between a rule strategy sequence, the rule strategies, and the rules, consistent with an embodiment of the present invention. As shown in FIG. 2, a rule strategy sequence 70 comprises a plurality of rule strategies 80 and 81. A rule strategy can be of the type ‘inclusive’ or ‘exclusive’. A rule strategy sequence must comprise at least one rule strategy of type inclusive.

An inclusive rule strategy A 80 defines which locations or products should be taken into account by the availability check. An exclusive rule strategy B 81 defines which locations or products should be excluded from the availability check. For example, if the inclusive rule strategy comprises the locations L1, L2 and L3 and the exclusive rule strategy comprises the location L2, then the locations L1 and L3 have to be considered by the availability check, but not location L2. Locations and products according to a rule strategy are given by the corresponding rules.

Rule strategy A 80, which is an inclusive rule strategy, comprises a plurality of rules 90, 91 and 92. Each of these rules may be of the type ‘inclusive’ or ‘exclusive’, whereby at least one inclusive rule has to be assigned to the inclusive rule strategy A 80. An inclusive rule 90, 91 within an inclusive rule strategy 80 defines which location or products should be considered by the availability check. An exclusive rule 92 within an inclusive rule strategy 80 defines which products or location has to be excluded from the availability check. For example, if inclusive rule 90 defines the locations L1 and L2, the inclusive rule 91 location L3 and exclusive rule 92 the locations L1 and L3, then the location L2 has to be considered by the availability check. This means that the exclusive rules of an inclusive rule strategy are applied to the inclusive rules of this rule strategy.

The rule strategy B 81, which is an exclusive rule strategy, comprises a plurality of rules 93, 94 and 95. Each of these rules may be of the type ‘inclusive’, ‘exclusive’ or ‘alternative’. Inclusive rule 93 within an exclusive rule strategy defines products and locations which are excluded from the availability check. Therefore, the exclusive rule 94 within an exclusive rule strategy defines an exclusion from the exclusion given by the inclusive rule 93. In this way, exclusions from exclusion may be modeled. For example, if the inclusive rule 93 defines locations L1 and L2 to be excluded from the availability check and exclusive rule 94 defines the location L1 as exclusion, then location L1 has to be considered by the availability checked, even if L1 is excluded by rule 93. Alternative rule 95 within an exclusive rule strategy 81 defines alternative locations or products for locations or products which are excluded by inclusive rule 93. This means that the exclusive rules and the alternative rules of an exclusive rule strategy are applied to the inclusive rules of this rule strategy. The exclusive rule strategies are applied to the inclusive rule strategy.

In one embodiment, rule strategies and the rules may be determined using a condition technique. The condition technique provides means for selecting a set of rule strategies or a set of rules according to a plurality of parameters, for example product A and location L1 or other customer related properties, and a plurality of access sequences. Therefore, the locations and products according to a rule strategy sequence may depend on various customer and order related properties.

In order to fulfill the requirement, that the ordered products are shipped only from a predetermined number of locations to the customer, the ATP rules and the rule strategies may comprise several attributes which are evaluated during the determination of the rule strategies and the ATP rules. An ATP rule comprises the attributes maximum number of substitutions (technical name: NRECS) and restricted object.

The field ‘Maximum number of substitutions’ (NRECS) defines how many substitutions of the original location, product or location product are allowed to be part of the total confirmation of an availability check. Substitutions in this context mean how many different products, locations or location products the resulting list of an availability check can have. It is possible to have no restrictions (NRECS=0 equivalent to NRECS=No restriction) or to restrict the number of substitutions to a predefined number. In one embodiment, the maximum number of substitutions may be set equal to 1 (NRECS=1), for example. If the maximum number of substitutions is set equal to 1, the total confirmation of an availability check comprises only products out of exactly one location or exactly one product out of a specific location. Exactly one location means that the total confirmation comprises products only from one location. Exactly one product out of a specific location means that the total confirmation comprises only one single product from one specific location. The product alternative that is selected may be only one single product from one single location.

In order to differentiate between restriction of location, restriction of product, restriction of location product and no restriction, the attribute ‘Restricted object’ is defined and may be customized in an ATP rule. This attribute may have the following values: not defined, location, product, or location product. The value ‘not defined’ means that the restricted object is not specified within the ATP rule, i.e., the values may come from a previous ATP rule or from a rule strategy. In the first case, the ATP rule inherits the values for the fields ‘Maximum number of substitutions’ and ‘Restricted object’ from a previous ATP rule. If no previous ATP rule exists, or a previous ATP rule has also the value ‘not defined’ set for the field ‘Restricted object’, than the ATP rule behaves as if the value ‘no restriction’ would have been set for the field ‘Maximum number of substitutions’. This means that no restriction is specified.

The values ‘location’, ‘product’ and ‘location product’ mean that the total confirmation is restricted according to the object location, product and location product. A rule strategy may comprise the attributes Maximum number of substitutions (NRECS), Restricted object, and Activation flag. The meaning of the attributes ‘Maximum number of substitutions’ and ‘Restricted object’ is the same as described above for ATP rules. For the rule strategy the attribute ‘Restricted object’ can have the following values: location, product, or location product. These attributes, defined on a rule strategy, are considered across all rules defined for a rule strategy. This means, that the attributes on a rule strategy level overwrite the attributes on rule level. A further attribute, the activation flag, is used to activate these attributes on rule strategy level. If the activation flag is not set on rule strategy level, the values on rule level are used even if on rule strategy level values for these attributes have been set. If the activation flag is set on rule strategy level, then the values of the rule strategy are used in all ATP rules of this rule strategy. These attributes are considered only for the above mentioned inclusive rule strategies because exclusive rule strategies are not used for checking the availability but only to reduce the possible number products, locations or location products.

All possible combinations of the attributes are valid and shown in the following Table 1.

TABLE 1

| Activation | Restricted | Maximum number | |
|---|---|---|---|
| flag | entity | of substitution | Possible result |
| — | — | — | Values at rule level are |
| | | | used |
| set | Location | No restriction | No restriction at all |
| | | 1 substitution only | Only one single location |
| | | | in result |
| | Location | No restriction | No restriction at all |
| | product | 1 substitution only | Only one single location |
| | | | product at all |
| | Product | No restriction | No restriction at all |
| | | 1 substitution only | Only one single product |
| | | | in result |

The following example demonstrates how these attributes work on a rule strategy level and shows the difference to the attributes on a rule level.

An evaluation of the rule strategy RS1 leads to the ATP rules Rule1 and Rule2. The required or ordered quantity is 100 pieces. The subsequent availability check leads to the following results:

| | | | |
|---|---|---|---|
| Rule1: | P1/L1 | 20 pieces confirmed | Px/Ly describes the |
| | P1/L2 | 80 pieces confirmed | product x in location y |
| Rule2: | P2/L1 | 50 pieces confirmed | |
| | P3/L1 | 30 pieces confirmed | |

If the activation flag on rule strategy RS1 is not set and the restriction ‘1 substitution only’ for the restricted object ‘Location’ is set on each ATP rule then there would be no final confirmation. According to Rule1, only 20 pieces in location L1 or 80 pieces in location L2 could be confirmed. According to Rule2, only 80 pieces in location L1 could be confirmed.

If the same restrictions are set on rule strategy RS1 and if the activation flag on rule strategy RS1 is also set, then the complete 100 pieces could be confirmed with products P1, P2 and P3 in Location L1:

| | |
|---|---|
| P1/L1 | 20 pieces confirmed |
| P2/L1 | 50 pieces confirmed |
| P3/L1 | 30 pieces confirmed |

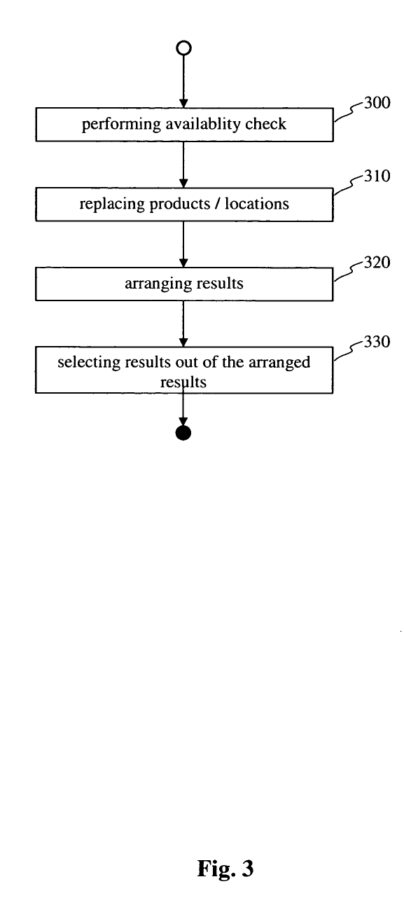

FIG. 3 shows a flow diagram of an exemplary method, consistent with an embodiment of the invention. As shown in FIG. 3, the method starts with step 300 by checking the availability of the ordered products according to the customer order. Checking availability creates a result which comprises, for example, the products, location and available quantity. If the ordered products are not available or available only in part within the checked location, the method may perform a step 310 of replacing the product and/or the location with another product and/or location, respectively. In one embodiment, the replacement is done according to the ATP rules. After replacing any product and/or location, the method may perform a further availability check with the replaced product and/or location. Then, after checking availability of each product with each location according to the ATP rules, step 320 is performed.

In step 320, results of the availability checks are arranged according to product and location. Thus, an ordered list of products is built-up. In one embodiment, the results are inserted after each availability check into an arranged result, wherein the arrangement of the results survives.

In step 330, a plurality of results is selected from the arranged results, wherein the number of different locations and/or products with the selected results corresponds to a predetermined number of different locations and/or results. In one embodiment, step 330 may be performed after each availability check in order to minimize the number of availability checks.

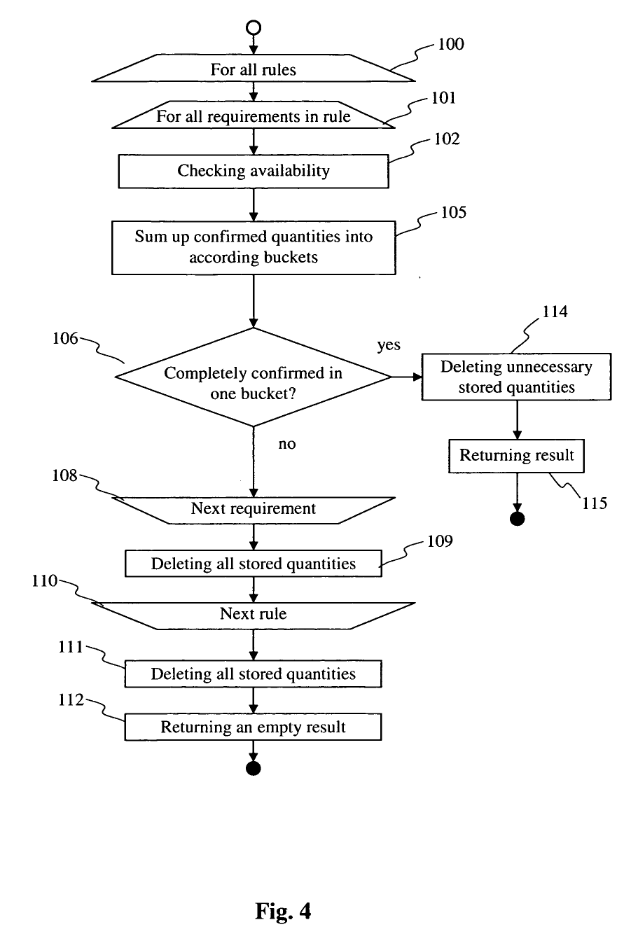

FIG. 4 shows a flow diagram of another exemplary method, consistent with an embodiment of the invention, wherein an activation flag on a rule strategy is not set. As described above, the attribute values are not overwritten by the respective rule strategy and the attribute values defined on each ATP rule are used.

The availability check process may call a rule determination method which determines a rule strategy sequence and a plurality of rule strategies. The result of the rule determination method is a set of ATP rules. This set of ATP rules is one of the input parameters called by the ATP controller. Further, input parameters may be the required quantity of products. The ATP controller may be an external program which triggers the method.

For each rule 100, the method determines a plurality of requirements. For each requirement 101, the method performs steps 102 to 106. For each first requirement in step 102 the availability of the requested quantity of products is checked. For each location the confirmed quantities are stored in the respective buckets. The confirmed quantities within each bucket are summed up within step 105. Within the following step 106 it is checked whether a bucket can confirm the required quantity. If there exist a bucket which can confirm the required quantity, the method proceeds with step 114 as described below. Otherwise, the method continues by processing the next requirement at step 108.

Using the values stored in the buckets, the exemplary method of FIG. 4 may calculate the ‘actual requested quantity’ according to the following formula 1:
ARQ_{LOC}=ORQ_{LOC}−ACQ_{LOC} (formula 1)

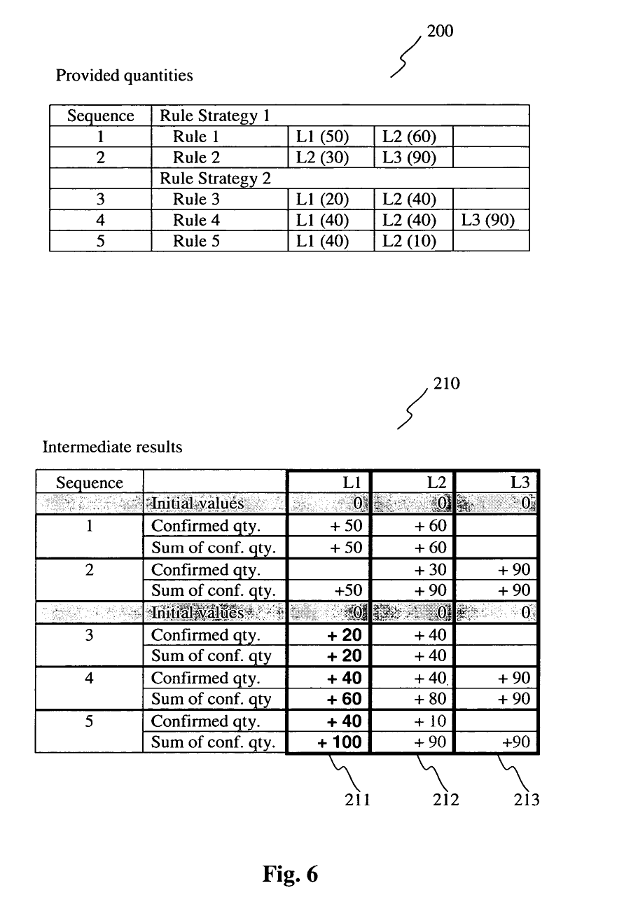

In formula 1, ARQ_{LOC} is the actual requested quantity for location LOC, ORQ_{LOC} is original requested quantity for location LOC and ACQ_{LOC} is the aggregated confirmed quantity of location LOC. A detailed description about these buckets is given below in FIG. 6. Within the first iteration, the ACQ_{LOC} is equal to zero for all locations.

The value of ARQ_{LOC} is considered by the availability check during processing the next requirement. If this availability check confirms the ARQ_{LOC} then the method goes to step 114. Now, the method is able to build a resulting list containing only products from one location. All unnecessary stored quantities, i.e., all buckets for the other locations, are deleted. In step 115, the resulting list is built and returned to the ATP controller. The method terminates and returns to the ATP controller.

If the whole ARQ_{LOC} is not confirmed by the availability check, in the next step the confirmed quantity is stored in one of the said buckets. This is also shown below in FIG. 6, for example. If the attribute ‘restricted object’ is set to the value ‘location product’, the confirmed quantity is not stored in the buckets. This means that while processing the next requirement the method considers the whole requested quantity. This is necessary to fulfill the condition that the result should contain exactly one product from one location. The technique of checking all location products with the original requested quantity and so to get the maximum possible quantity for each location product enables the search for an optimal confirmation result. The method provides means which enables to plugging in customer specific programs which may select the best or another result from the check results.

If further requirements exist 108, the method returns to step 101 and processes the next requirement. If not, all stored quantities in the buckets are discarded in step 109 and the next rule is processed.

After processing the last rule, the method removes all stored quantities from the buckets, in step 111, builds an empty resulting list, in step 112, and returns to the ATP controller.

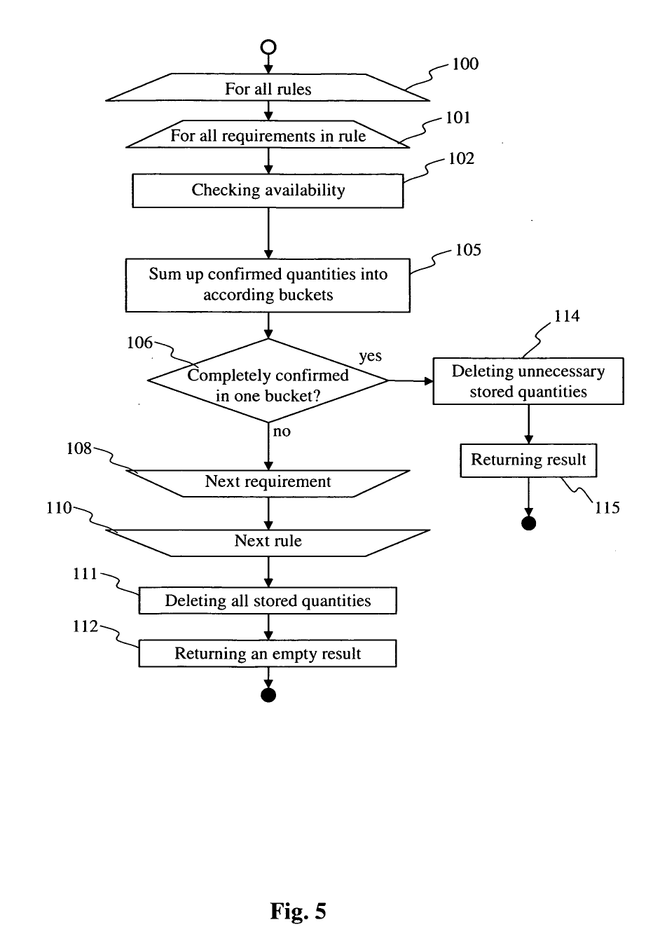

FIG. 5 shows a flow diagram of yet another exemplary method, consistent with an embodiment of the invention, wherein an activation flag on a rule strategy is set. As described above, the attribute values are overwritten by the respective rule strategy. The difference between the program flow in FIG. 5 and the program flow shown in FIG. 4 is that the intermediate results in the buckets after processing all requirements of an ATP rule are not discarded. This way, the method is able to determine products from one location across all ATP rules within one rule strategy.

The exemplary methods, described in FIG. 4 and FIG. 5, may be executed for several rule strategies within a rule strategy sequence. If a further rule strategy is evaluated, then new buckets are created since the restriction does not work across rule strategies.

FIG. 6 shows exemplary data tables, consistent with an embodiment of the present invention. Upper table 200 shows the confirmed quantities by the availability check according to the ATP rules Rule 1 to Rule 5. For example, the location L1 provides 50 pieces of a product according to the ATP rule Rule 1. Rule 1 and Rule 2 belong to Rule Strategy 1 and Rule 3 to Rule 5 belong to Rule Strategy 2. The first column ‘Sequence’ indicates the sequence in which the ATP rules are evaluated and checked for availability.

Lower table 210 shows the intermediate results according to the inventive method. In this example, the attributes on the rule strategies are set to the following values:
Maximum number of substitutions (NRECS)=1
Restricted object=Location
Activation flag=Set

Since the activation flag is set on rule strategy level, the attribute values for the attributes ‘Maximum number of substitutions’ and ‘Restricted object’ on the ATP rules are overwritten by the values of the rule strategies.

Columns 211, 212, 213 represent the above-mentioned buckets for locations L1, L2 and L, respectively. The column ‘Sequence’ shows the sequence in which the ATP rules are processed by the inventive method. During processing, the method creates for each location, or in another embodiment for each location product, a bucket for storing the aggregated confirmed quantities (sum of confirmed quantities). Table 210 shows additionally the confirmed quantity for each location within each step. In one embodiment, the actual requested quantity may be stored also in the respective buckets (not shown in FIG. 6). The actual requested quantity is calculated according to the above mentioned Formula 1.

In this example, the ordered quantity of a product is 100 pieces. Accordingly, the actual requested quantity within the first processing step (Sequence 1) is set equal to 100 for locations L1 and L2. In the first processing step, ATP rule Rule 1 is evaluated, whereby the availability check confirms 50 pieces for location L1 and 60 pieces for location L2. These confirmed quantities are stored in the respective buckets (+50 and +60).

In the second processing step (Sequence 2), ATP rule Rule 2 is evaluated and checked. According to the requirements of Rule 2, location L3 is checked. Since location L3 has not been checked during the first processing step, the method creates a new bucket for location L3 and the actual requested quantity for location L3 is set equal to 100. Within this second processing step for locations L2 and L3, 30 and 90 pieces are confirmed, respectively (+30 and +90), whereby for location L2 the actual required quantity of 40 pieces (100−60) is used for checking the availability.

After each processing step, the sum of confirmed quantities within each bucket is calculated. For example, after the second processing step sum of confirmed quantities are +50, +90 and +90 for locations L1, L2 and L3 respectively.

The Rule Strategy 1 is now completely evaluated and checked for availability. Location L1 can provide 50 pieces, the location L2 90 pieces (30+60) and the location L3 90 pieces. None of the locations can provide the whole quantity of 100 pieces. According to Rule strategy 1, the method is not be able to confirm the ordered quantity of products from one location.

Since a second Rule Strategy 2 is maintained for the actual rule strategy sequence, the method continues by processing the ATP rules according to Rule Strategy 2. Prior to processing the third ATP Rule 3 (sequence 3), the method removes all entries from each existing buckets. In one embodiment, the buckets as such may be deleted not only the entries. This means that the intermediate results for Rule Strategy 1 are invalid and the confirmed quantities are set equal to zero (Initial values in Table 210). During the third processing step, ATP Rule 3 and locations L1 and L2 are evaluated. The actual required quantities are set equal to 100 and an availability check is done considering locations L1 and L2. For locations L1 and L2, 20 pieces and 40 pieces (+20 and +40) are confirmed, respectively, and stored in the respective buckets.

The fourth processing step (sequence 4) is performed in the same way as the second processing step: a bucket for L3 is created if there does not exist yet and the actual requested quantity for location L3 is set equal to 100. The actual requested quantities for location L2 and L3 are calculated according to the Formula 1 (80=100−20 and 60=100−40). The fourth processing step performs an availability check for the locations L1, L2 and L3 considering the actual requested quantities 80, 60 and 100. This processing step confirms 40, 40 and 90 pieces for the locations L1, L2 and L3.

These confirmations are used to calculate the actual requested quantities during the fifth processing step (Sequence 5). Now the sum of confirmed quantities according to the previous processing steps three and four are used to determine the new actual requested quantities for the locations. The aggregated quantities for the locations L1, L2 and L3 are 60 (20+40), 80 (40+40) and 90 (0+90). The new actual requested quantities are considered by the availability check within the processing step 5. The fifth processing step confirms 40 pieces for location L1 and 10 pieces for location L2.

The method checks within each processing step after processing whether or not the location can fulfill the ordered quantity of products by calculating the sum of confirmed quantity. Within the fifth processing step, after checking the availability according to the location Li and after storing the confirmed quantity (40) in the bucket, the method checks the aggregated quantity for location L1. The aggregated quantity of location L1 is the sum of the confirmed quantities (20+40+40) out of the first bucket 211. In this case the aggregated quantity is equal to 100 and therefore the location L1 can fulfill the ordered quantity. The method terminates and hands over to the calling system a resulting list containing all confirmations. Before returning to the calling system, the method removes all entries from the buckets 212 and 213. The remaining availability check for location L2 is not executed any more. This remaining availability check would confirm a quantity of 10 pieces.

The buckets may be implemented as a linked list in which each item of the linked list comprises at least the confirmed quantity. Each list is identified by a location, a product or a location product.

In a further embodiment, a global class is used for the storage of the aggregated confirmed quantities per location or location product. This class stores a table of locations and products. For each location, product the aggregated confirmed quantities is stored. During evaluation process it is checked whether a restriction of location or location products is defined on the ATP rule or on the rule strategy which is actually evaluated. If such a restriction exists, then for every evaluated ATP rule the above mentioned global class is called which checks whether or not an instance of the class itself has to be created. An instance of the class is created for every ATP rule if the restriction is defined on rule level. If the restriction is defined on rule strategy level, then a new class instance is only created for the rule strategy and not for the single ATP rule.

The determined or created class instance is then returned to the evaluation process. The ATP controller creates a requirement group and stores the reference to the class instance in the requirement group. That way each requirement group can access the right bucket via the class reference.

If the availability check confirms a partial confirmation, then the confirmed quantity is added to the aggregated confirmed quantity of the right location/product column of the class instance. The class manages itself by keeping an account of all existing class instances per rule strategy or rule, respectively, so the class knows itself if a new instance has to be created or an existing class instance has to be used and returned to rule evaluation process.

The present techniques and embodiments described herein, including the exemplary systems and methods presented above, can be implemented in digital electronic circuitry, or in computer hardware, firmware, software, or in combinations of them. Apparatus consistent with embodiments of the invention can be implemented in a computer program product tangibly embodied in a machine-readable storage device for execution by a programmable processor. Method steps according to embodiments of the invention can be performed by a programmable processor executing a program of instructions to perform functions or steps of methods consistent with embodiments of the invention by operating on the basis of input data, and by generating output data. Systems and method consistent with embodiments of the invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in ASICs (application-specific integrated circuits).

Computer systems or distributed computer networks, such as those mentioned above, may be used, for example, for producing goods, delivering parts for assembling products, controlling technical or economical processes, or implementing telecommunication activities.

To provide for interaction with a user, embodiments of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A computer-implemented method for processing a customer order specifying products and required quantities of the products, the method comprising:
performing a plurality of availability checks for the specified products with at least one location, wherein each availability check creates a result that comprises one or more products, locations, and available quantities;
replacing the products and corresponding locations if a sum of available quantities within each of the results does not correspond to a required quantity of the specified products;
arranging the results according to product and location; and
selecting a plurality of results from the arranged results, wherein at least one of a number of different locations and a number of different products within the plurality of results is predetermined.

2. The computer-implemented method of claim 1, wherein the at least one availability check is performed based on at least one ATP rule that indicates an object to be restricted within the plurality of results, wherein the object is at least one of a location and product.

3. The computer-implemented method of claim 2, wherein the at least one ATP rule further indicates at least one of the predetermined number of different locations and the predetermined number of different products.

4. The computer-implemented method of claim 3, wherein the at least one ATP rule is determined by evaluating a rule strategy sequence, wherein the rule strategy sequence comprises at least one rule strategy and the at least one rule strategy comprises at least one ATP rule.

5. The computer-implemented method of claim 4, wherein the at least one rule strategy indicates the object to be restricted within the selected plurality of results and wherein the object is at least one of a location and product.

6. The computer-implemented method of claim 5, wherein the at least one rule strategy further indicates at least one of predetermined number of different locations and predetermined number of different products.

7. The computer-implemented method of claim 6, wherein the at least one rule strategy indicates whether or not the at least one of predetermined number of different locations and predetermined number of different products and the object to be restricted of the at least one ATP rule are overwritten with the at least one of predetermined number of different locations and predetermined number of different products and the object to be restricted of the at least one rule strategy.

8. The computer-implemented method of claim 7, wherein at least one of predetermined number of different locations and predetermined number of different products comprises at least one of the values ‘no restriction’ and ‘one different object’.

9. The computer-implemented method of claim 1, wherein the method performs an availability check with respect to all location products in order to determine the maximum available quantity for each location product.

10. The computer-implemented method of claim 1, wherein the method provides an interface for plugging in external programs for selecting the best result from the availability check process.

11. The computer-implemented method of claim 1, wherein the method further comprises:
determining and evaluating at least one rule strategy; and
determining and evaluating the ATP rules of the determined at least one rule strategy.

12. The computer-implemented method of claim 11, further comprising:
determining the requirements of the ATP rule.

13. The computer-implemented method of claim 12, wherein the method further comprises, for each requirement:
checking availability for the required quantity of products;
aggregating the confirmed quantities with respect to the location and storing the aggregation within a bucket; and
checking whether or not the a bucket can provide the requested quantity.

14. The computer implemented method of claim 13, wherein the actual requested quantity is the difference between the required quantity of products and the stored confirmed quantity of products.

15. An apparatus comprising:
a data storage that stores a plurality of ATP rules, a plurality of rule strategies, a plurality of rule strategy sequences and confirmed quantities;
means for determining at least one rule strategy sequence, at least one rule strategy, and at least one ATP rule;
means for aggregating the confirmed quantities with respect to a location and storing the aggregation;
means for determining an actual requested quantity; and
means for checking availability according to at least one of a required quantity of products and the actual requested quantity of products.

16. The apparatus of claim 15, further comprising:
means for performing availability checks for the specified products with at least one location, wherein each availability check creates a result that comprises one or more products, locations, and available quantities;
means for replacing the products and corresponding locations if a sum of available quantities within each of the results does not correspond to a required quantity of the specified products;
means for arranging the results according to product and location; and
means for selecting a plurality of results from the arranged results, wherein at least one of a number of different locations and a number of different products within the plurality of results is predetermined.

17. A computer-readable medium storing program instructions for processing a customer order specifying products and a required quantity of the products according to a method, the method comprising:
performing availability checks for the specified products with at least one location, wherein each availability check creates a result that comprises one or more products, locations, and available quantities;
replacing the products and corresponding locations if a sum of available quantities within each of the results does not correspond to a required quantity of the specified products;
arranging the results according to product and location; and
selecting a plurality of results from the arranged results, wherein at least one of a number of different locations and a number of different products within the plurality of results is predetermined.

18. A computer-implemented method, the method comprising:
providing a plurality of ATP rules, a plurality of rule strategies, a plurality of rule strategy sequences and confirmed quantities;
determining at least one rule strategy sequence, at least one rule strategy, and at least one ATP rule;
aggregating the confirmed quantities with respect to a location and storing the aggregation;
determining an actual requested quantity; and
checking availability according to at least one of a required quantity of products and the actual requested quantity of products.
